(19) United States
(12) Patent Application Publication
(10) Pub. No.: US 2018/0120832 A1
(43) Pub. Date: May 3, 2018

(54) UNMANNED AIRCRAFT SYSTEMS (UAS) ROBOTIC-PLATFORM (DRONE) MANAGEMENT

(71) Applicants: Melvin Marx Hintze, Mackay, ID (US); Kristen Ruth Thompson, Meridian, ID (US); Darla Ann Hintze, Mackay, ID (US)

(72) Inventors: Melvin Marx Hintze, Mackay, ID (US); Kristen Ruth Thompson, Meridian, ID (US); Darla Ann Hintze, Mackay, ID (US)

(21) Appl. No.: 15/335,989

(22) Filed: Oct. 27, 2016

(51) Int. Cl. G05D 1/00; B64C 39/02; G07C 5/00; B64D 45/00

(52) U.S. Cl. CPC G05D 1/0022; B64C 39/024; G07C 5/008; G08C 2201/61; B64C 2201/146; B64D 2045/0085; B64D 45/00

(57) ABSTRACT

An Unmanned Aircraft Systems (UAS), automated management method is invented for civilian unmanned aerial vehicle (UAV) safe, controlled and accountable deployments. The method includes an attachable electronic module, use of a computerized networked enterprise (CLOUD), biometric operator authentication, all of which provides automated identification, GPS tracking location data and recording of all relevant information. The method's two separate hard-wired electronic modules are invented to provide many security and commercial entities, these include; flight platform electronic marking and identification, authorized operator authentication, operator documented training qualifications, systems setup and initialization.

### TECHNICAL FIELD

The present invention is a method and associated computerized electronic and software system for managing UAS. This invention and methodology starts with initialization, authorization, record keeping, operator identification, authentication and qualification. These married technical components continue through flight deployment and return to base and conclusion of flight.

### Acronyms List (Alphabetical Order)

Internet Based Cellular Telephone Network Accessible Enterprise with capabilities to store and process third-party information and data—(CLOUD)

Unmanned Aerial Vehicles (UAV) or Unmanned Aircraft System—(DRONE)

A Latin expression meaning “and other things” or “and so on” (Etc.)

An agency of the U.S. Dept. of Transportation Federal Aviation Admin.—(FAA)

Global Positioning System—(GPS)

A person's Identification—(ID)

Unmanned Aircraft Systems—(UAS)

Unmanned Aerial Vehicle—(UAV)

Universal Serial Bus or standardized connection for computer peripherals—(USB)

### BACKGROUND

UAVs (Drones), are being deployed by civilian individuals, schools, law enforcement, search and rescue, government agencies and businesses for various purposes. These purposes including photography, wildlife observation, exploration hobbies, recreational trail mapping, crop inspection, security and visual control programs. Authority having Jurisdiction management of regulatory requirements are in the earliest stage of development. Note the following one example; “FEDERAL REGISTER Vol. 80, No. 35, Monday, Feb. 23, 2015, Part III, Dept. of Transportation, FAA, 14 CFR Parts 21, 43, 45, et al., “Operation and Certification of Small Unmanned Aircraft Systems”; Proposed Rule”. Current and proposed Regulatory requirements and their respective enforcement are extremely time consuming and will have extensive labor resources. This invented method proposes efficient automation for meeting regulations, commercial and security needs, applications and other UAV requirements.

### SUMMARY

The present invention (UAS) provides a method comprising a computerized electronic management and accountability method for application to civilian UAV (DRONE) systems. The method includes: [1] An attachable pre-programed radio-linked electronic module with identification and control parameters, [2] a single unit fingerprint reader biometric operator authentication module integrated into the respective UAV's remote command and control assembly, [3] and an associated separate continuous real-time accountability and computing system radio linked to the attachable electronic module and deployed within a cell-telephone type networked enterprise (CLOUD). The UAS can be made instantaneously accessible at any U.S.A. location (including, but not limited to, territories, off shore expanses, Etc.) serviced by a Cell Telephone network. The accessibility of the UAS is for computing, processing and storing the respective operating robotic platform's relevant and or desired information (identification, location, history, speed, GPS, etc.). The CLOUD or enterprise deployed computing system can be programmed with Global Positioning System (GPS) templates and or overlays to instantaneously direct and or control and prevent the platform from entering into prohibited locations. The enterprise deployed computing system can be programmed to respond to problems such as loss of controller's communication, approaching or entering prohibited locations or other security concerns, wherein the enterprise system will command, direct or send the respective robotic platform back to its GPS initial deployment location or another predetermined location. The platform's respective “attachable” module is a hard-wired unit with a permanently pre-programmed memory. The attachable module's memory includes and retains, but is not limited to information such as: (A) The robotic platform's operator's and owner's name, (B) The operator's authorization (licensing, training qualification certification, etc.), to deploy, (C) The platform's identification, make and model, licensing number etc., and (D) a copy of the operator's scanned fingerprint for biometric ID authentication. The single unit fingerprint reader biometric operator authentication module, part of this design, is a commercially available off-the-shelf operator authentication fingerprint scanner. It has associated hardware and software, which will be mounted on, electronically integrated into, and powered by the UAV's radio linked commercially available operator hand-actuated ground control assembly.

In the said Setup and Initialization phase, the system will have an authentication module that will obtain and process the potential operator's fingerprint scan and retain this image. The biometric ID will be stored in the authentication module which is attached to and electronically integrated into respective operator's hand controller. The function of the authentication module memory when required, will issue or allow a “go” or “no-go” to the respective adjacent platform's controls thus assuring that only an authorized person is operating the unit. During the platform's pre-operation and operational phase, periodically, an indicator light and/or audible sound from the ID authentication module will request repeated conformation of an authorized operator by obtaining and comparing additional fingerprint scans. The original and repeated periodic fingerprint biometric authentication scanned images will not be disclosed or transmitted outside of the respective platform's ground operator controlling hardware and will only be used to generate a go or no-go indication within the controlling hardware. The associated separate computing system (CLOUD), which is continuously radio linked with the operating UAS's attached electronic module, is constantly processing information obtained through a cell-telephone type network and provides the following (but not limited to): (A) Instantaneous platform identification, (B) Permanent record keeping and historical data (GPS, Etc.). This system will also receive and store operator “go” and “no-go”, (but not an actual fingerprint scan), from ground hand-controls biometric authentication information. It will monitor and store the respective platform's GPS location and confirm compliance with certain, if any, restrictive space, velocity and timing during the entire operational mode.

### DESCRIPTION TECHNICAL

This computerized electronic hardware and software system can be visually explained in FIG. 1, FIG. 2, FIG. 3 and FIG. 4 respectively.

The network enterprise (CLOUD) (cell telephone type) data and communication computerized system processes certain information and determines that each specific UAS platform “is”, or “is-not”, authorized. Authorization is in conjunction with its respective operator and the location and intended flight path in space and time acceptable criteria for public safety and for guarding operation within unrestricted locations. The UAS management method allows, under normal conditions, UAV remote control by an approved operator on the ground. In the event of certain problematic conditions, controlled autonomously by an onboard preprogrammed electronic-computerized module, allows the system to be removed from the planned direction and returned to a safe location if necessary. The network enterprise (CLOUD) continuously monitors performance and location of said UAS. Upon the UAS experiencing certain pre-programmed flight conditions, the CLOUD will initiate irreversible control change to the onboard electronic-computerized module. These system flight conditions would include, but are not limited to, loss of communication with operator, the eminent entry into restricted space and improper time constraints. Only then will the onboard electronic-computerized module direct the UAS to pursue a safe flight path and termination or conclusion of operations.

### BRIEF DESCRIPTION OF THE FIGURES (BLOCK DIAGRAM SHEETS)

FIG. 1 illustrates a Registration, Setup and Initialization flowchart of all the invented system's components.

FIG. 2 illustrates a Pre-Flight operation flowchart of the remaining systems used to affirm authorized operation in accordance with the proposed invention's configuration.

FIG. 3 illustrates a normal Flight operations of the systems in the proposed invention.

FIG. 4 illustrates a Problematic-Flight operation of the systems for response to conditions in accordance with the proposed invention.

### INDEX OF CLAIMS

1. Programmer Assembly, Registration, Authorization, Operator Identification, Initialization, Setup, Programming.
2. UAS Setup and Initialization, Programming, UAS Attachable Computerized Electronic Module, Cloud Communication.
3. UAS Setup and Initialization, Attachable Pre-Programmable Module, Biometric Operator Authentication, Programming, Cloud Communication.
4. UAS Pre-Flight Methodology, Operator Identification and Authentication, CLOUD Communication.
5. UAS Flight Operation Methodology, Periodic Operator Authentication, CLOUD Communication.
6. UAS Problematic Flight Management.
7. UAS Attachable Pre-Programmed Computerized Electronic Module Flight Details.
8. UAS Authorized Operator Authentication Continuity Affirmation during Flight.
9. UAS Attachable Pre-Programmed Computerized Electronic Module Flight Authorization Switch.
10. UAS Active Flight Termination and Fail-Safe.
11. UAS Computerized Automatic Drone System Management Invention Suitable for Supporting Interception of Unidentifiable UAV Platforms.

What is claimed is:

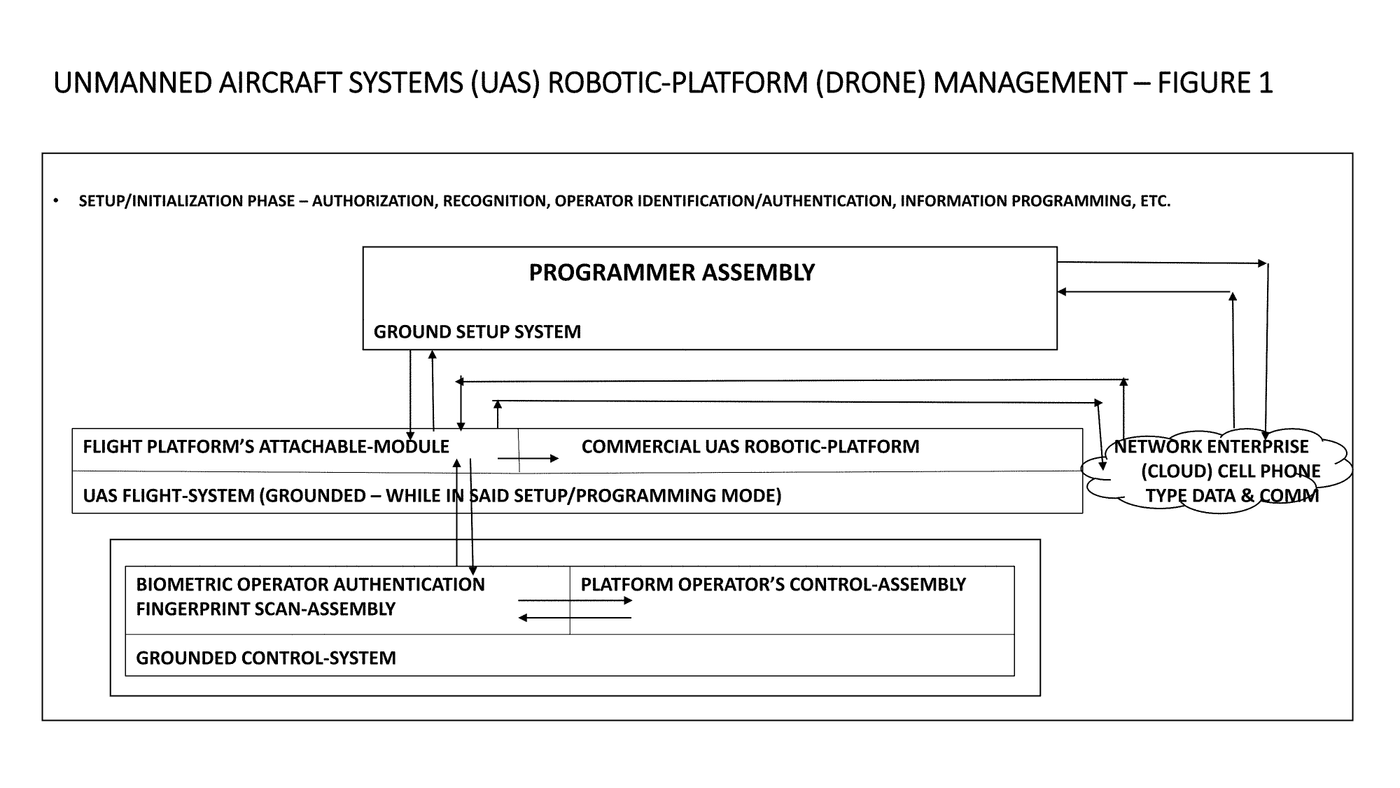

1. A method of computerized automatic Drone System Management comprising: Information received by said system, for registration, setup and initialization methodology (see FIG. 1); the invention is for a Programmer Assembly (see FIG. 1), that provides a UAS with authorized and programmed information required for eventual flight operation; after the Programmer Assembly's input information is complete, the system is invented for said Programmer Assembly to record into the unmanned aerial vehicle (UAV) platform's attachable computerized electronic module initialization information such as, but not limited to, Authority Having Jurisdiction's registration and licensing, the respective operator's identification and qualifications for operating this particular platform (See FIG. 1).

2. A method of computerized automatic Drone System Management as claimed in claim 1. further comprising: A setup and initialization methodology is invented where a UAS's “Flight Platform's Attachable-Module” receives, from the “Programmer Assembly”, digitized information required for eventual flight operation including, but not limited to, a unique Identification number or code password from said “Programmer Assembly (see FIG. 1)”; this information is retained into the platform's Attachable Module's permanent memory and is then transmitted or transferred to the “Network Enterprise (CLOUD)”, using cell phone type data and communication, thus enabling the CLOUD to, affirm registration, authorization, track and record the position and performance of said UAV; if and when necessary, it will address the UAV through the “Flight Platform's Attachable-Module”; the CLOUD's computer could then, if necessary, take over operation by (if and as required), removing the operator's link which would automatically transfer UAS control to the “Flight Platform's Attachable Module”; thus, the methodology would implement total non-operator command and control of the unmanned aerial vehicle (UAV) platform as necessary.

3. A method of computerized automatic Drone System Management as claimed in claim 2. further comprising: A setup and initialization methodology is invented that uses a temporary USB direct electrical communication to the UAS's “Flight Platform's Attachable-Module”, to receive and store in its memory, a “Biometric Operator Authentication Fingerprint” imprint from a “Biometric Operator Authentication Fingerprint Scan-Assembly”; the Scan Assembly or device will be permanently attached to the UAV “platform operator's hand-controlled assembly”; this scanned and received imprint will simultaneously be recorded permanently in both the “ground operator's hand-controlled assembly” and said UAV's “flight platform's attachable-module”; this subpart of the invention is for periodically obtaining an affirmation, (only the affirmation and not the actual fingerprint scan), that the authorized UAS's operator is actuating the said hand-controlled assembly; the affirmation indication, not the actual fingerprint scan, will be transmitted to and recorded in the CLOUD for later use during actual UAV flight; this subpart of the invention being setup during the initialization phase will verify and maintain that only the appropriate authorized operator is using the UAS's respective hand-control assembly during actual and entire UAV flight.

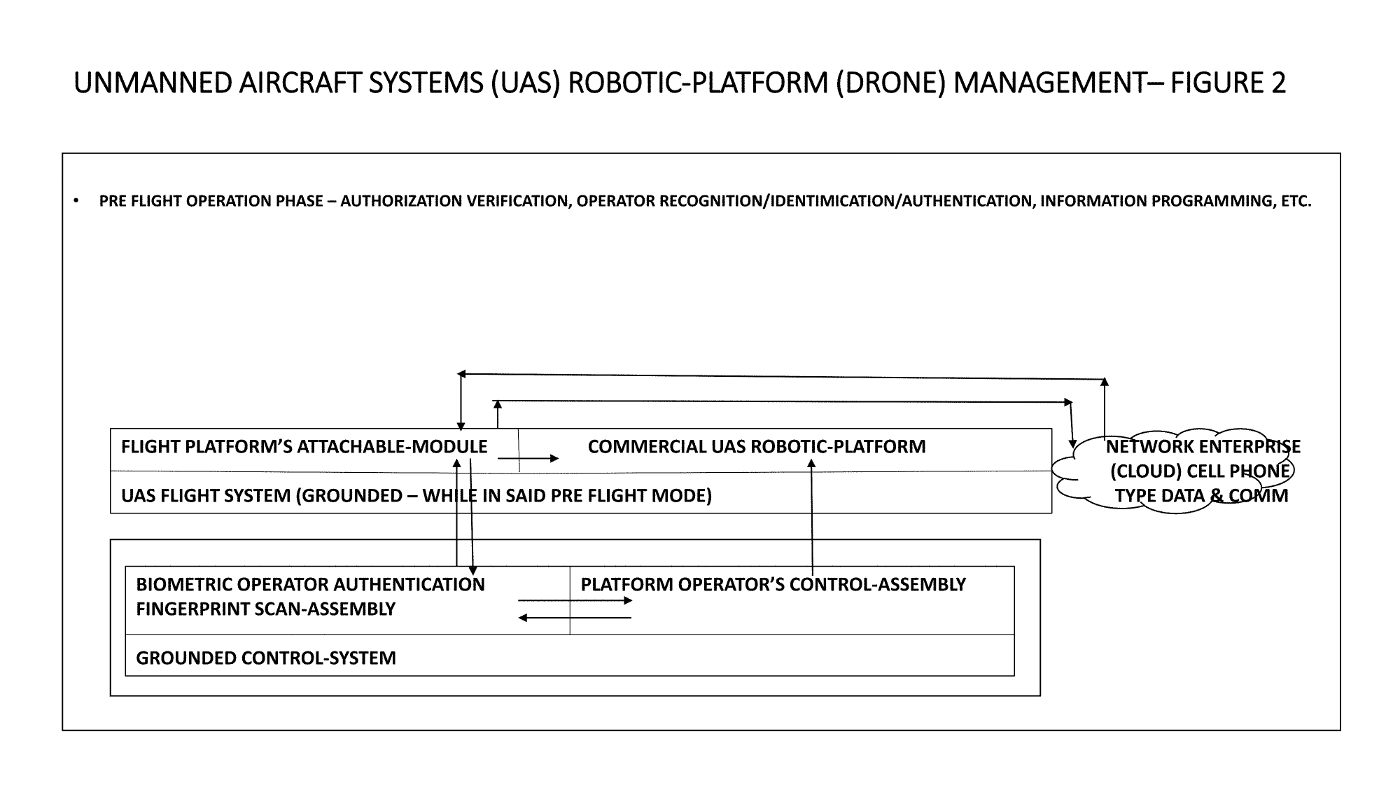

4. A method of computerized automatic Drone System Management as claimed in claim 3. further comprising: A Pre-Flight Operation methodology (see FIG. 2) is invented wherein, a UAS is electrically energized and prepared for flight operations; this invention proposes to coordinate all of the Unmanned Aerial Vehicle (UAV) platform's necessary information; this platform information includes but is not limited to, (1) the respective operator's identification, (2) fingerprint biometric authentication, and (3) current qualifications for operation of the platform; this information will be transmitted to the “network enterprise (CLOUD)”, using cell phone type data and communication for the purpose of receiving a “go” or “no-go” indication for the pending launch and continuous flight operation of the platform or Drone.

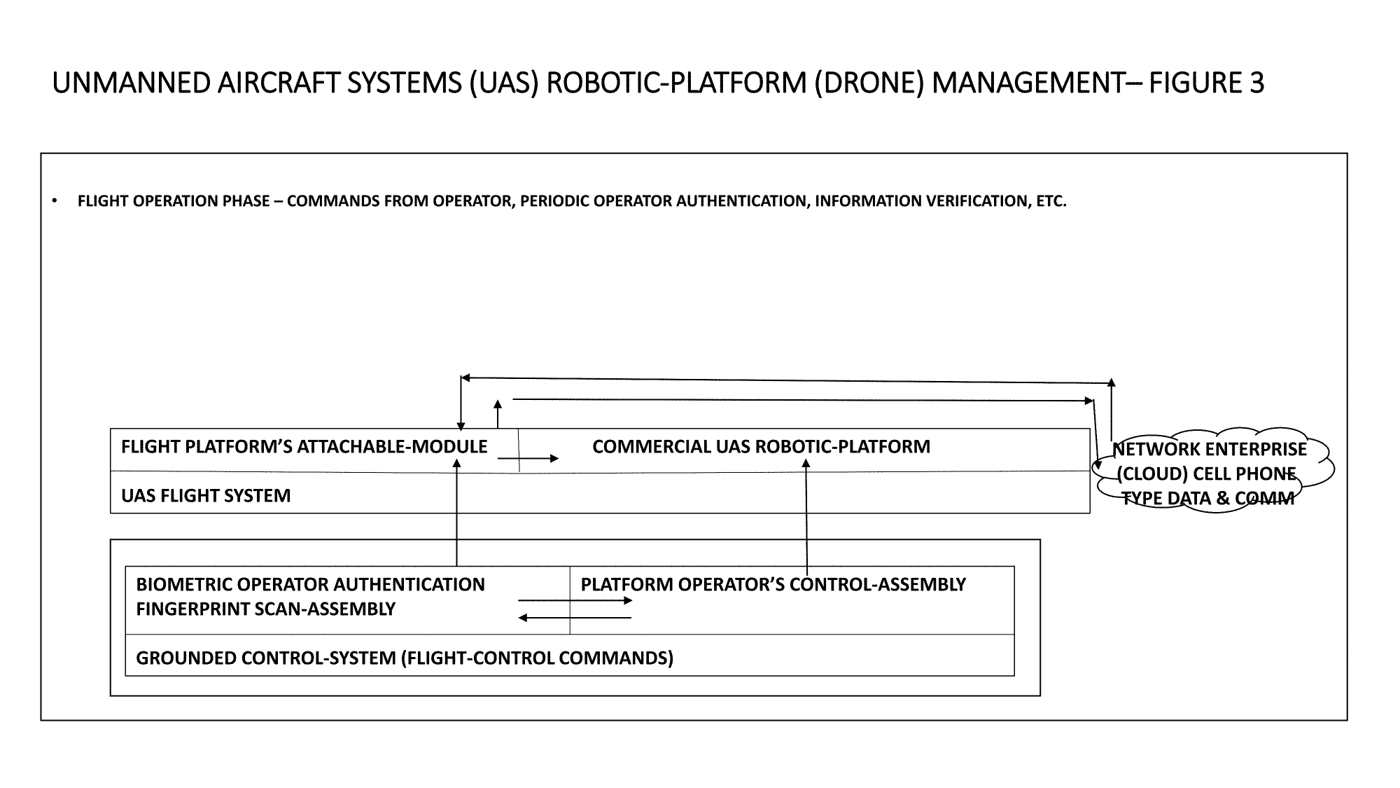

5. A method of computerized automatic Drone System Management as claimed in claim 4. further comprising: A Flight Operation methodology as claimed in Claim's 1., 2., 3. and 4. and shown in FIG. 3, further comprising a method for which a UAS is controlled, during flight operations phase, to operate, track, monitor and manage the platform's performance and its respective information; this performance includes but is not limited to, (1) the respective operator's periodic fingerprint biometric authentication while controlling the platform and (2) Certain information that is periodically transmitted to the “network enterprise (CLOUD)”, using cell phone type data and communication for the purpose of receiving a continuing “go” or “no-go” indication for the flight operation of the platform; this makes the platform only operational by a secured identifiable operator; (3) also a Flight Operation Methodology (see FIG. 3) is invented, wherein while a UAS is in flight operations affirmation that only the authorized operator is actuating the “ground command and control” console; this is done by receiving and comparing periodic scans of the respective operator's fingerprint for biometric authentication from the hand-control console's “biometric operator authentication fingerprint scan-assembly”; this action affirms proper operator involvement of the platform with certain information periodically transmitted to said “network enterprise (CLOUD)”, using cell phone type data and communication for the purpose of receiving a continuous “go” or “no-go” indication for the flight operation of the platform; (4) also a Flight Operation Methodology (see FIG. 3.), of a UAS that is in flight operations, is invented to affirm that only the UAV's flight path and GPS data is acceptable; this affirmation is accomplished through coordination of information with its respective CLOUD system and with certain information periodically transmitted to said “network enterprise (CLOUD)” using cell phone type data and communication; this specifically makes the platform operational only within prescribed GPS coordinates.

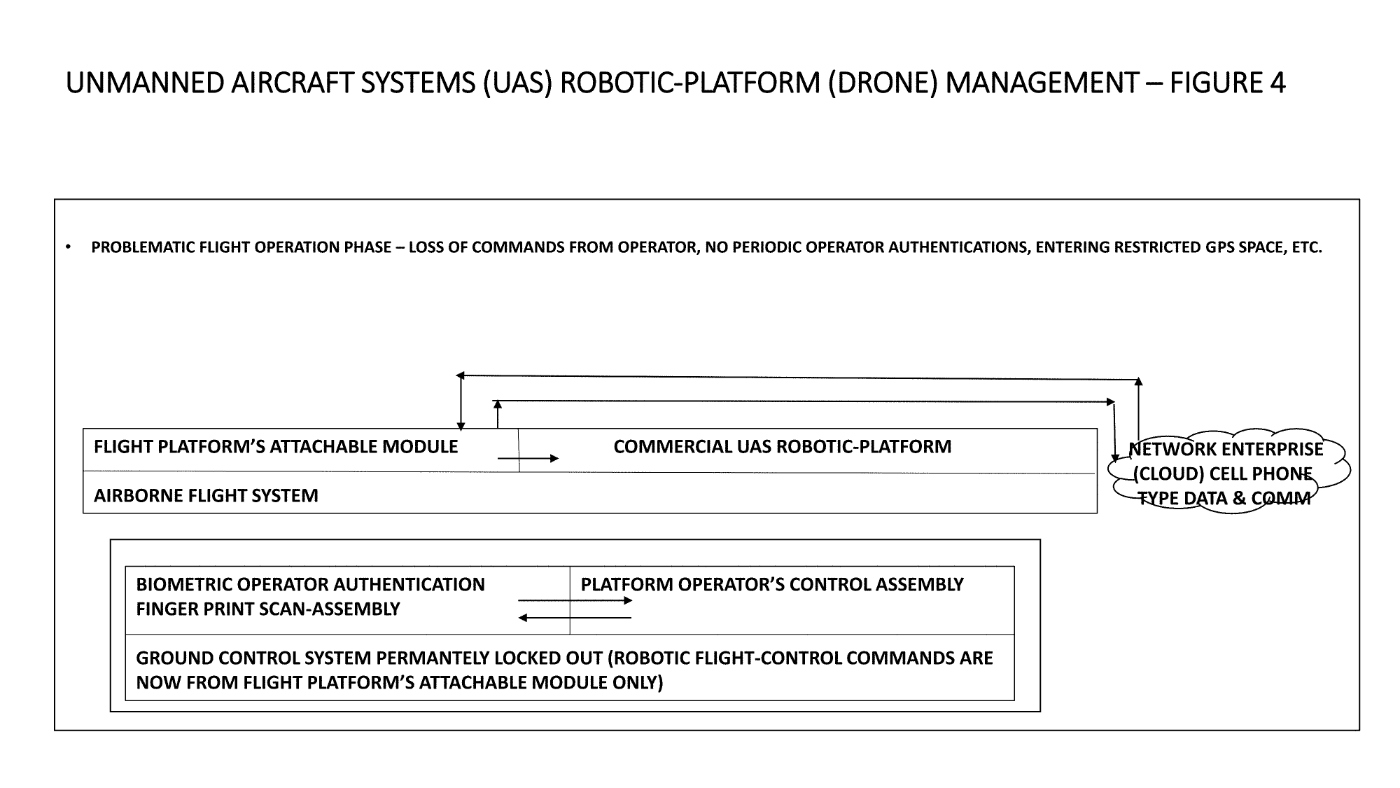

6. A method of computerized automatic Drone System Management as claimed in claim 5. further comprising: A Flight Operation Methodology to monitor and manage the unmanned aerial vehicle (UAV) platform's performance information (see FIG. 4), wherein when said UAS is in Problematic Flight Operation mode, is invented to operate, control, track said UAS; this management includes, but is not limited to, “Problematic Flight Operations” of the platform; if certain information indicating problems are transmitted to the “network enterprise (CLOUD)”, using cell phone type data and communication, then the continuing “go” will be changed to a “no-go” indication, and the flight operation status of the platform will not be maintained; this allows a said designated authority or owner, the ability to abort a flight under certain circumstances should that become necessary; a problematic flight operation methodology is invented (see FIG. 4) to assure safety and continuing control of the platform; for example, two, but not limited to only these two, problematic UAV flight operations would be to prevent an unauthorized operator assuming command, or for prevention of the platform's entry into incorrect or restricted air space; hypothetical condition resulting, when certain adverse information being transmitted to the CLOUD's computer system, would result in a “no-go” indication for the flight operation of the platform; wherein, using this invention's preprogrammed adverse conditions, the operator's ground based hand-actuated controls would be immediately “Locked Out” and the UAV's “flight platform's attached module” would assume complete command and control and initiate a “return to launch location” or other suitable termination of flight operations.

7. A method of computerized automatic Drone System Management as claimed in claims 1., 2., 3., 4. and 5. further comprising the attachable pre-programmed computerized electronic module wherein recorded platform identification information such as operator biometric identification, registration and licensing from the Authority Having Jurisdiction, Etc.; this information when communicated to the associated hosted computing and data storage system (CLOUD) for confirmation or denial for operational authorized activation and deployment of said platform; this received and recorded information after communicated to the CLOUD will confirm identity of the DRONE along with its authorized operator or lack thereof;
this part of the invention is a prerequisite for initial launch and also a requirement for continued flight operations.

8. A method of computerized automatic Drone System Management as claimed in claim 7. further comprising: the method of claim 3. wherein the attachable pre-programmed computerized electronic module has the respective operator's scanned fingerprint biometric identification for affirmation of associated operator's legal and proper registration and licensing from the Authority Having Jurisdiction; this information, affirmation only and not actual fingerprint scan, when communicated to the associated hosted computing and data storage system (CLOUD) for comparison to affirmations of correct periodic fingerprint scans from the UAS's hand-operated control assembly, will allow or deny continued operational authorized activation and deployment of said platform; in other words, this received and recorded information, when communicated to the CLOUD, will confirm the identity of the respective DRONE along with affirmation of its control by an authorized operator or lack of either or both thereof.

9. A method of computerized automatic Drone System Management as claimed in claim 8. further comprising: The method of claims 1., 2., 3., 4., 5. and 8. wherein the invented attachable pre-programmed computerized electronic module receives platform and operator identities and authorized activation and deployment information from the associated hosted computing and data storage system; if the above information is acceptable, the module will change a “normally-open” electrical contact switch to a “closed” condition thus allowing the respective robotic platform to be activated for actual flight mobility and use; during actual flight operation, the said electrical switch will remain in a “closed” state as long as acceptable conditions for authorized activation and deployment exist.

10. A method of computerized automatic Drone System Management as claimed in claim 9. further comprising: The method of claims 4. and 5. wherein said platform is active and operational, the attachable preprogrammed computerized electronic module will provide periodic performance and location checks, using GPS and other instrumentation of the respective platform's position and performance; this information will be transmitted to the hosted computing and data storage system (CLOUD), for processing and examination; if the platform is experiencing adverse circumstances such as communication and or control problems or entering, or soon to enter, restricted space, or not performing properly, or not receiving periodic proper operator biometric identification, the hosting computing system and or the attached electronic module by itself, will initiate a controlled and safe deactivation routine such as return to point-of-origin, or other appropriate fail-safe command and/or proceed to an alternative predetermined flight terminating location.

11. A method of computerized automatic Drone System Management as claimed in claim 5. further comprising: This invented computerized electronic management methodology, with its hardware and complementary hosting CLOUD computer and software, is suitable for application for identifying, tracking and supporting the interception of any unidentifiable UAV platforms.
